(19) United States
(12) Patent Application Publication
(10) Pub. No.: US 2019/0234146 A1
(43) Pub. Date: Aug. 1, 2019

(54) AUTOMATIC BONDING SYSTEM FOR GROUNDING MOBILE EQUIPMENT

(71) Applicant: Halliburton Energy Services, Inc., Houston, TX (US)

(72) Inventor: Glenn Howard Weightman, Duncan, OK (US)

(73) Assignee: Halliburton Energy Services, Inc., Houston, TX (US)

(21) Appl. No.: 16/328,193

(22) PCT Filed: Oct. 11, 2016
(86) PCT No.: PCT/US2016/056449

§ 371 Date: Feb. 25, 2019

(51) Int. Cl. E21B 7/02; H01R 4/66; H02G 13/00; H01R 13/648

(52) U.S. Cl. CPC E21B 7/02; H01R 13/648; H02G 13/40; H01R 4/66

(57) ABSTRACT

In some aspects, the present disclosure includes methods and systems for grounding mobile equipment at a site, such as a hydrocarbon drilling and production site. In one embodiment, the system comprises a mobile unit; one or more ground rods configured to penetrate a portion of a grounded surface; one or more grounding connectors coupled to the one or more ground rods and the mobile unit; and one or more actuators coupled to the mobile unit. The one or more actuators may be used to drive the one or more ground rods into the portion of the grounded surface, thereby creating an electric flowpath to allow for the discharge of electricity.

### TECHNICAL FIELD

The present disclosure relates generally to electrical grounding, and more particularly, to bonding systems and methods of use for grounding mobile equipment at a site, such as a hydrocarbon drilling and production site.

### BACKGROUND

A protective earth conductor (“PE”), also referred to as an equipment-grounding conductor, is an important piece of safety equipment used at construction and manufacturing sites. The PE provides a conductive path from a piece of equipment to the earth. During normal operations, many types of equipment can build up high levels of static electricity. A worker or other passerby who happened to touch an exposed conductive surface on the piece of equipment could then suffer an electrical shock. Using electrical grounding, such as that provided by a PE, dissipates this electric buildup, and thus eliminates the dangers of electric shock. Moreover, some electrical equipment could experience an internal short or fault that could result in a power surge exposing those standing in the nearby vicinity to extremely large electric currents. Proper earth grounding not only reduces or eliminates the threat of personal injury due to static charge build-up and power surges, but can also help protect the equipment itself from said power surges, as well as other power surges such as those from lightning strikes, which can cause power failures, damage electronic equipment, or otherwise create costly and inconvenient problems.

A field site, such as a manufacturing plant, construction zone, or a hydrocarbon drilling and production site, will generally include a multitude of specialized equipment, mobile office trailers, storm shelters, satellite trailers, generators, and distribution panels for various facilities. Electrical grounding is required for all of these items, as well as many others, in order to ensure and protect the health and safety of nearby workers and visitors, and to maintain electrical machinery in proper working order. The requirements for grounding at a field site are set by the National Electrical Code (“Code”). Typically, grounding at a field location is performed to Code by the use of a copper plated ground rod that is placed into the earth. Each separate trailer or piece of electrical equipment is grounded separately in the usual course of operations. A bare copper wire is bonded to the ground rod and connected to each trailer or piece of equipment, thereby forming an electrical connection with the ground rod. This process of placing a ground rod and connecting it with the trailer or equipment must be repeated each time for each piece of equipment that enters or leaves a field site.

The duplicative nature of this process creates several issues at a field site. First, operators are less likely to go through the time consuming and effort intensive process of properly grounding any given piece of equipment, particularly those that are frequently moved or for which there is an expected short period of installation at a particular field site. However, failure to properly install the PE compromises equipment integrity and worker safety. Second, if the operators do properly install the ground rods and associated wiring, the resulting clutter poses a significant trip and fall hazard due to the multitude of exposed ground rods and connecting wires at a field site.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a side view of a bonding system in accordance with certain embodiments of the present disclosure.

FIG. 2 is a close up view of an actuator in accordance with certain embodiments of the present disclosure.

FIG. 3 is a close up view of an actuator in accordance with certain embodiments of the present disclosure.

FIG. 4 is a close up view of an actuator in accordance with certain embodiments of the present disclosure.

FIG. 5 is a close up view of an actuator in accordance with certain embodiments of the present disclosure.

FIG. 6 is a close up view of an actuator in accordance with certain embodiments of the present disclosure.

FIG. 7 is a close up view of an actuator in accordance with certain embodiments of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

The present disclosure relates generally to electrical grounding, and more particularly, to bonding systems and methods of use for grounding mobile equipment at a site such as a hydrocarbon drilling and production site. A protective earth conductor (“PE”), also referred to as an equipment-grounding conductor, is an important piece of safety equipment used at construction and manufacturing sites. Generally, a PE may comprise a copper plated ground rod placed in the earth and a connecting wire bonded to the ground rod and a particular trailer or piece of equipment. Traditionally, each particular trailer or piece of equipment requires its own ground rod and connecting wire. The time and effort required to install proper grounding for each trailer and piece of equipment often results in operators choosing not to ground the equipment at all. Furthermore, if the operators do properly install the ground rods and associated wiring, the resulting clutter poses a significant trip and fall hazard due to the multitude of exposed ground rods and connecting wires at a field site.

As discussed in greater depth below, the present disclosure provides methods and systems to simplify and automate the bonding and grounding process. According to certain aspects, the present disclosure provides a ground rod that is placed into the earth using a linear actuator. The linear actuator and the ground rod may be permanently attached to a particular trailer or piece of equipment. Alternatively, the present disclosure provides a ground rod that is coupled to the landing legs of a trailer such that setting the landing legs of the trailer places the ground rod into the earth. The present disclosure also provides a ground rod that is in the shape of an auger. The present disclosure also provides a ground rod that may be placed into the ground using an air drill or powder charge. The present disclosure also provides a ground rod that may be placed into the ground through the action of setting a lowboy trailer on the ground.

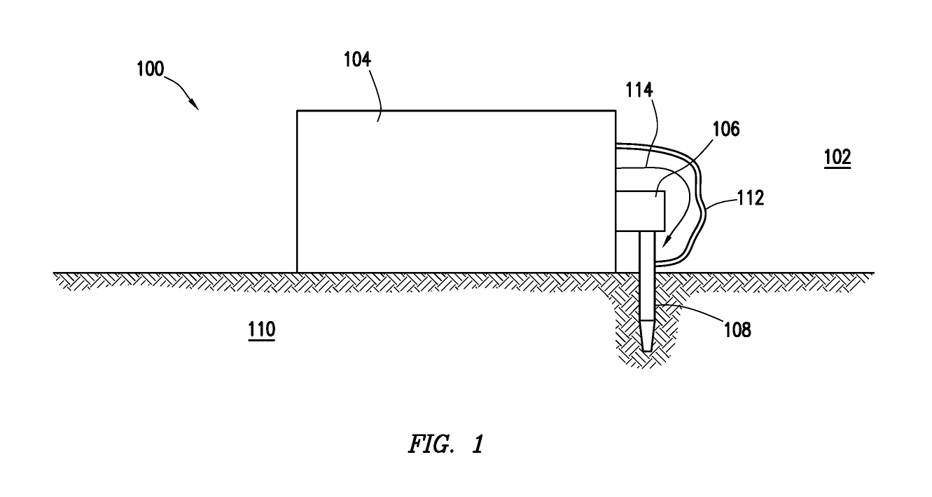

The present disclosure may be better understood with reference to FIGS. 1 through 6, where like numbers are used to indicate like and corresponding parts. FIG. 1 is a side view of a mobile bonding system in accordance with the present disclosure. Bonding system 100 is shown at field location 102. Field location 102 may be a well site, construction site, manufacturing site, hydrocarbon drilling and production site, or any other site where equipment and mobile trailers may need to be installed. Bonding system 100 comprises mobile unit 104. Mobile unit 104 may be installed at field location 102. Mobile unit 104 may be any oilfield equipment unit including, but not limited to, a mobile trailer temporarily or permanently installed at field location 102. Mobile unit 104 may also be a temporary building or other portable building installed at field location 102. Alternatively, mobile unit 104 may be any piece of mobile equipment installed for operation at field location 102. Suitable mobile equipment includes, but is not limited to, pumps, blenders, electrical cabinets, electrical drives, motors, mixers, tanks, storage units, cranes, compressors, hoists, derricks, manlifts, excavators, drilling and boring equipment, mining equipment, conveyors, and any other equipment commonly used or required at field locations.

Bonding system 100 further comprises one or more actuators 106 coupled to a portion of mobile unit 104. Actuator 106 may be coupled to the exterior of mobile unit 104. Alternatively, actuator 106 may be attached or coupled to the interior of mobile unit 104. Actuator 106 may be coupled to mobile unit 104 in any suitable manner. For example, actuator 106 may be welded or bolted to mobile unit 104. In certain embodiments, the one or more actuators 106 may be linear actuators including, but not limited to, hydraulic cylinders, linear electric motors, air-operated cylinders, screw mechanisms, a rack and pinion system driven by a motor, and a rack and pinion system driven by a crank. In certain embodiments, the one or more actuators 106 may be the same as actuators used to set landing legs (not expressly shown) coupled to mobile unit 104. In one or more embodiments, the one or more actuators 106 may be an air drill or a powder or explosive charge. In certain embodiments, the one or more actuators 106 may further comprise a vibrating mechanism. As would be understood by one of ordinary skill in the art having the benefit of the present disclosure, in situations where more than one actuator 106 is required for a particular bonding system, each of the one or more actuators 106 may be the same type of actuator. Alternatively, the one or more actuators 106 may be different types of actuators.

Bonding system 100 further comprises one or more ground rods 108. In one or more embodiments, ground rod 108 may be a solid conductive tubular or a hollow conductive tubular. In one or more embodiments, ground rod 108 may further comprise one or more boring blades coupled to and extending spirally outward from an outer circumference of a conductive tubular. As would be appreciated by one of ordinary skill in the art, the term “conductive” is used herein to refer to any material having any tendency to allow electrical current to flow from one location to another. In certain embodiments, ground rod 108 may comprise copper plated galvanized steel. Ground rod 108 may be coupled to or extended from actuator 106. Alternatively, ground rods 108 may be initially coupled to, or extended from, actuator 106, but after installation of mobile unit 104 at field location 102, ground rods 108 may no longer be coupled to or extended from actuator 106. Once mobile unit 104 is installed at field location 102, ground rod 108 penetrates at least a portion of grounded surface 110. Grounded surface 110 may be a portion of earth. Alternatively, grounded surface 110 may be a pad constructed out of concrete, metal, or any other material that has itself been suitably grounded.

Bonding system 100 further comprises one or more grounding connectors 112 coupled to the one or more ground rods 108 and at least a portion of mobile unit 104. Grounding connectors 112 may comprise any conductive material known in the art. In certain embodiments, grounding connectors 112 may comprise copper or a copper plated material. In certain embodiments, grounding connectors 112 may be wires, quick-connect interfaces, slip-joints, or any suitable combination thereof. Grounding connectors 112 may be installed by coupling grounding connectors 112 to ground rods 108 and mobile unit 104 to create an electric flowpath 114 to allow the discharge of electricity from mobile unit 104 to grounded surface 110. In certain embodiments where grounding connectors 112 are wires, coupling the wires may generally comprise attaching the wire to at least a portion of ground rod 108 and an exposed and conductive portion of mobile unit 104. In certain embodiments where grounding connectors 112 are quick-connect interfaces, a quick-connect cable may be coupled to at least a portion of ground rod 108. A second quick-connect cable may be coupled to at least a portion of mobile unit 104. In certain embodiments where grounding connectors 112 are slip-joints, ground rod 108 may be at least partially disposed within a ring that is coupled to at least a portion of mobile unit 104. Ground rod 108 may be configured to slide outward from the ring, but would remain in contact with the ring at all times. Thus, even when ground rod 108 is installed in grounded surface 110, at least a portion of ground rod 108 would remain in contact with the ring. Grounding connectors 112 are always configured so that when properly installed, a completed electrical flowpath 114 is created.

The methods of the present disclosure generally provide for moving a mobile unit 104 to a field location 102 (such as a grounded surface) and grounding the equipment using a ground rod 108. This process may be done automatically by providing one or more actuators 106 that are directly coupled to, or incorporated into, mobile unit 104. The one or more actuators 106 are used to drive one or more ground rods 108 into grounded surface 110, penetrating at least a portion of the grounded surface 110. The ground rods 108 are coupled to the mobile unit 104 using one or more grounding connectors 112. Grounding connectors 112 may be pre-installed, or they may be installed at field location 102 once mobile unit 104 is in place. When grounding connectors 112 are installed at field location 102, operation of actuators 106 may automatically install grounding connectors 112. Alternatively, grounding connectors 112 may be pre-installed as shipped to field location 102 or manually installed by an operator at field location 102. Once ground rod 108 penetrates at least a portion of grounded surface 110 and grounding connectors 112 are coupled to ground rods 108 and mobile unit 104, an amount of electrical current may flow from mobile unit 104 to grounded surface 110. The amount of electrical current flow may vary depending on environmental conditions, situational conditions, or both. The electrical current flow may occur in bursts or in constant flow. The electrical current flow may be of a small amplitude or a large amplitude.

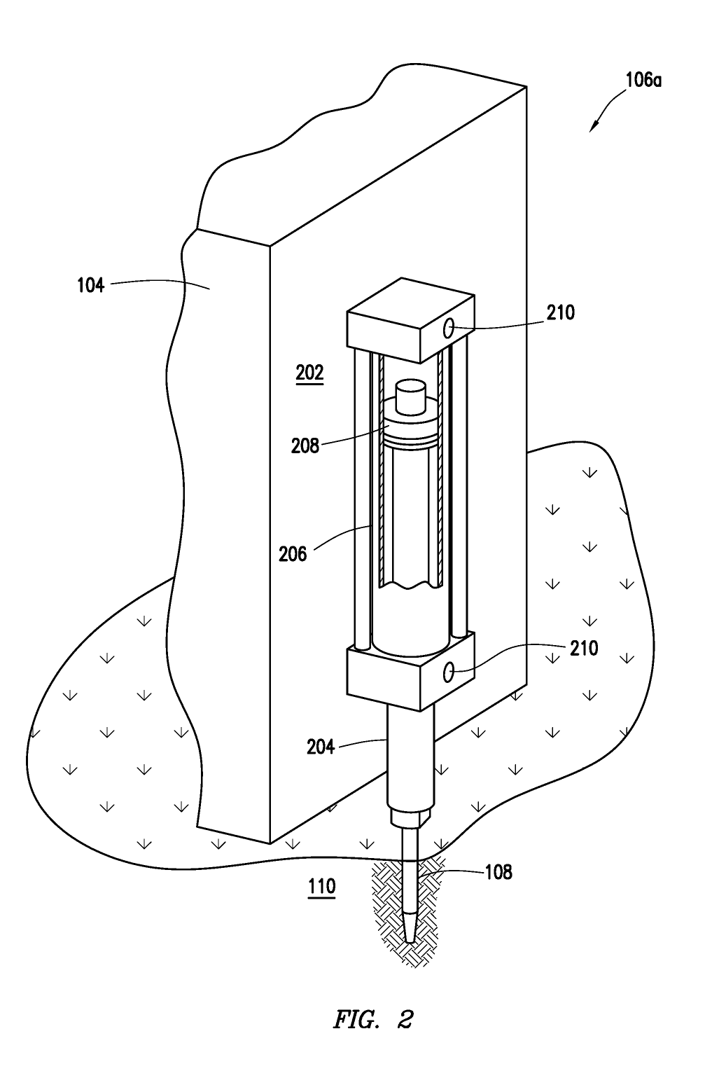

Referring now to FIG. 2, a close-up view of an actuator in accordance with the present disclosure is shown. Actuator 106 is shown as hydraulic cylinder 106a. Hydraulic cylinder 106a may be coupled to an exterior portion 202 of mobile unit 104. Hydraulic cylinder 106a may generally comprise a piston rod 204 partially disposed within a barrel housing 206. A piston 208 may be completely disposed within barrel housing 206 and coupled to a first end of piston rod 204. The second end of piston rod 204 extends outward from the base of barrel housing 206. The second end of piston rod 204 may be coupled to or in contact with ground rod 108. Barrel housing 206 may further comprise a plurality of ports 210 through which hydraulic cylinder 106a may be hydraulically actuated. During installation of mobile unit 104, an operator may actuate hydraulic cylinder 106a to push piston rod 204 downward towards grounded surface 110. As piston rod 204 pushes downward, it exerts a force against ground rod 108 sufficient to penetrate grounded surface 110.

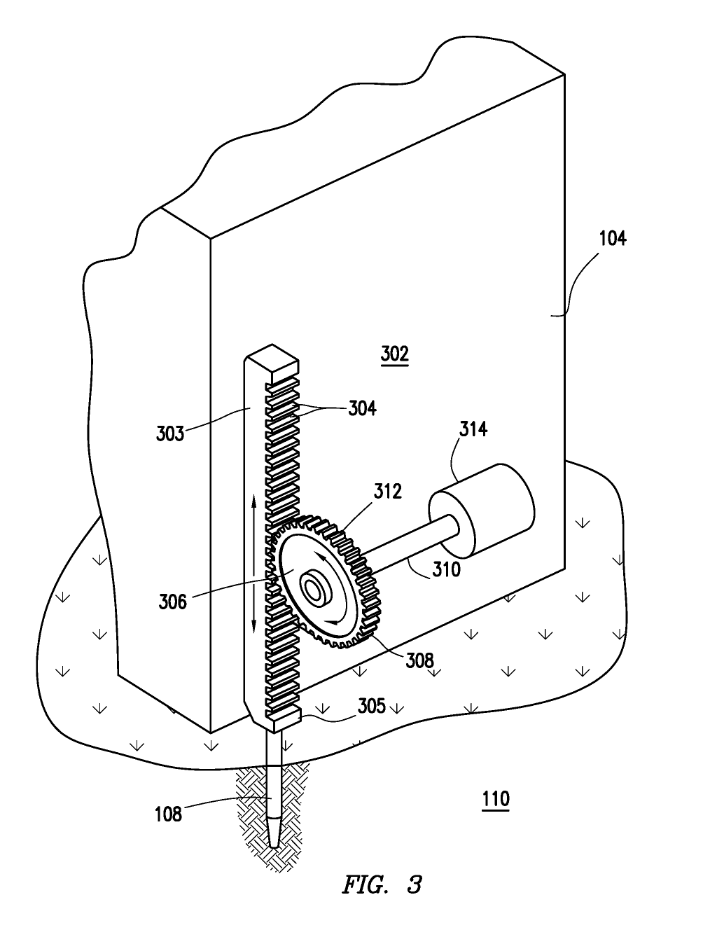

Referring now to FIG. 3, a close-up view of an actuator in accordance with the present disclosure is shown. Actuator 106 is shown as a rack and pinion mechanism 106b. Rack and pinion mechanism 106b may be coupled to an exterior portion 302 of mobile unit 104. Rack and pinion mechanism 106b may generally comprise rack 303. Rack 303 may comprise a straight piece of metal or other suitable material further comprising a series of protruding teeth 304 extending outward at least one side. One end 305 of rack 303 may be coupled to or contacting ground rod 108. Rack and pinion mechanism 106b may further comprise a pinion 306. Pinion 306 may comprise a generally circular disc having a series of protruding teeth 308 extending from its outer circumference and configured to engage with teeth 304 of rack 303. Pinion 306 may further comprise a drive shaft 310 extending from a flat face 312. Drive shaft 310 may be coupled to a motor 314. Motor 314 may be an electric motor, hydraulic motor, air motor, or any other suitable type of motor. Alternatively, drive shaft 310 may be coupled to a manual hand crank (not shown). During installation of mobile unit 104, an operator may actuate rack and pinion mechanism 106b by turning on motor 314 or manually turning the crank (not shown). As motor 314 rotates, it turns drive shaft 310 thereby rotating pinion 306. As pinion 306 rotates, the teeth 308 of pinion 306 engage with teeth 304 of rack 303 and cause rack 303 to slide downward in a linear direction towards grounded surface 110. As rack 303 slides downward, it pushes ground rod 108 into grounded surface 110, penetrating at least a portion thereof.

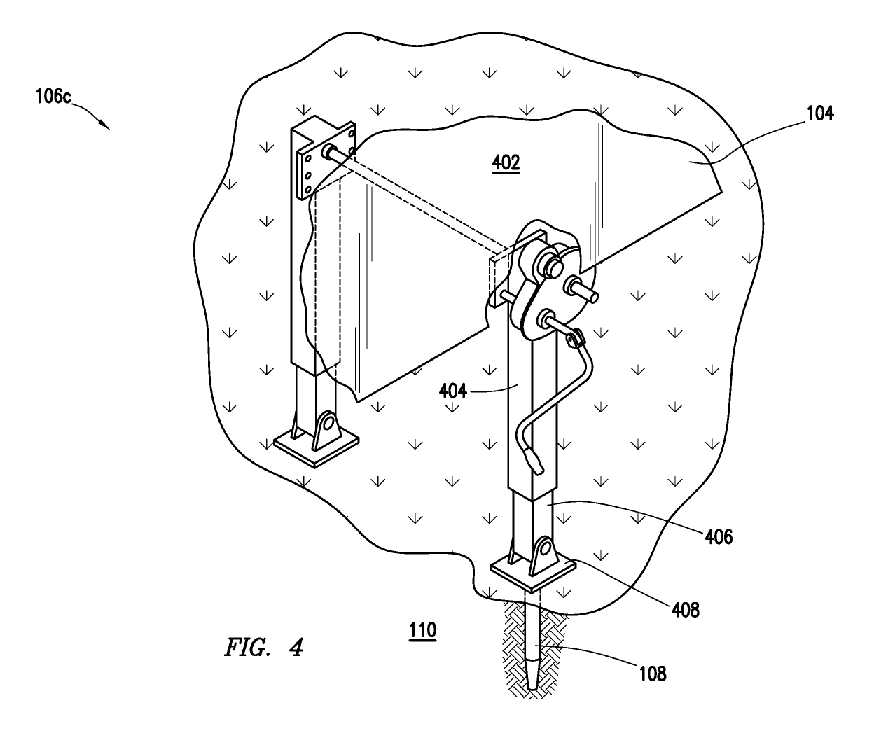

Referring now to FIG. 4, a close-up view of an actuator in accordance with the present disclosure is shown. Actuator 106 is shown as landing gear 106c. Landing gear 106c may be coupled to an exterior portion 402 of mobile unit 104. Exterior portion 402 of mobile unit 104 may be on the underside of mobile unit 104. Landing gear 106c may generally comprise a hollow rod 404 coupled to mobile unit 104. Landing gear 106c may further comprise extendable shaft 406 disposed within hollow rod 404 and capable of sliding downward from mobile unit 104 towards grounded surface 110. Landing gear 106c may further comprise landing foot 408 coupled to the bottom of extendable shaft 406. Ground rod 108 may be coupled to and extend from landing foot 408 such that ground rod 108 points generally toward grounded surface 110. Ground rod 108 may be permanently coupled to landing foot 408. Alternatively, ground rod 108 may be selectively coupled to landing foot 408 prior to installation of mobile unit 104 at a field location. Landing gear 106c may further comprise a crank 410 configured to extend extendable shaft 406. An operator may manually operate the crank 410. Alternatively, a motor (not shown) may operate crank 410. The motor may be a hydraulic motor, electric motor, air motor, or any other suitable motor. As crank 410 extends extendable shaft 406, landing foot 408 pushes ground rod 108 into grounded surface 110, penetrating at least a portion of grounded surface 110.

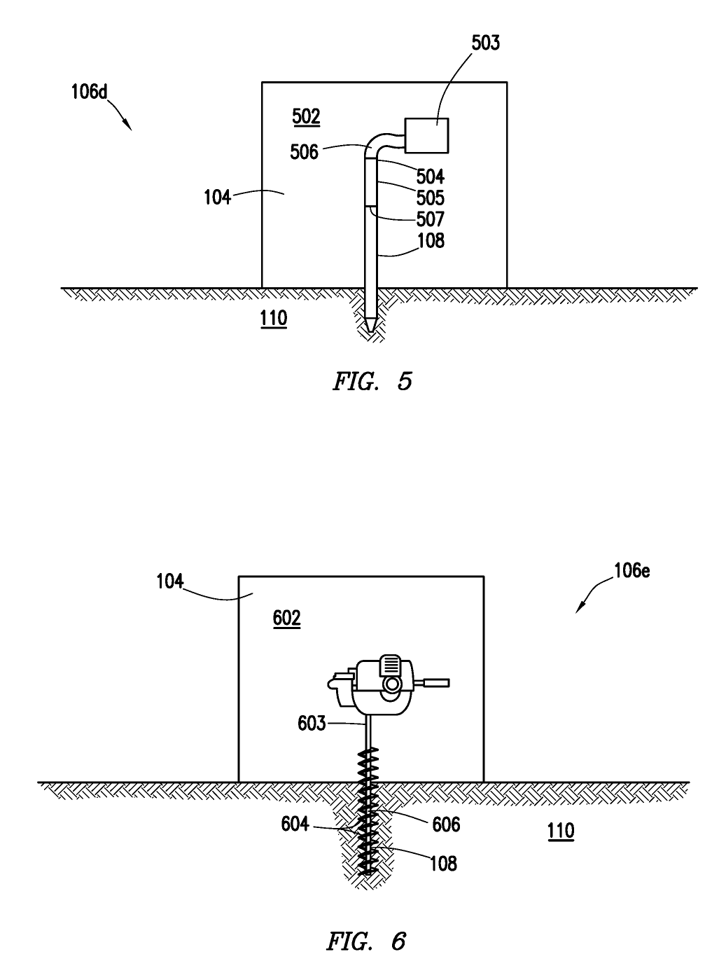

Referring now to FIG. 5, a close-up view of an actuator in accordance with the present disclosure is shown. Actuator 106 is shown as air drill 106d. Air drill 106d may be coupled to an exterior portion 502 of mobile unit 104. Air drill 106d may generally comprise a pneumatic air pump 503 coupled to mobile unit 104 and further coupled to a first end 504 of hollow rod 505. A tubing 506 may couple the pneumatic air pump 503 to the first end 504 of hollow rod 505. Ground rod 108 may comprise a hollow tubular that is coupled to a second end 507 of hollow rod 505. An operator may actuate pneumatic air pump 503 to blow air through hollow rod 505 and ground rod 108. A downward force may then be applied to hollow rod 505 to push ground rod 108 into grounded surface 110, penetrating a portion of the grounded surface 110. The operator may manually apply the force to hollow rod 505. Alternatively, a motor or other mechanism (not shown) may apply the downward force to hollow rod 505.

Referring now to FIG. 6, a close-up view of an actuator in accordance with the present disclosure is shown. Actuator 106 is shown as auger motor 106e. Auger motor 106e may be coupled to an exterior portion 602 of mobile unit 104. Auger motor 106e may comprise a hydraulic motor, an electric motor, an air motor, or any other suitable motor. Auger motor 106e may be coupled to a drive shaft 603 extending from ground rod 108. Drive shaft 603 may be coupled to auger motor 106e such that auger motor 106e may selectively rotate drive shaft 603 but drive shaft 603 may freely move in the longitudinal direction. Ground rod 108 may further comprise one or more boring blades 604 coupled to and extending spirally outward from an outer surface 606 of ground rod 108. An operator or other device may actuate auger motor 106e, thereby rotating drive shaft 603. As drive shaft 603 rotates, the one or more boring blades 604 of ground rod 108 may penetrate and bore a hole into at least a portion of grounded surface 110.

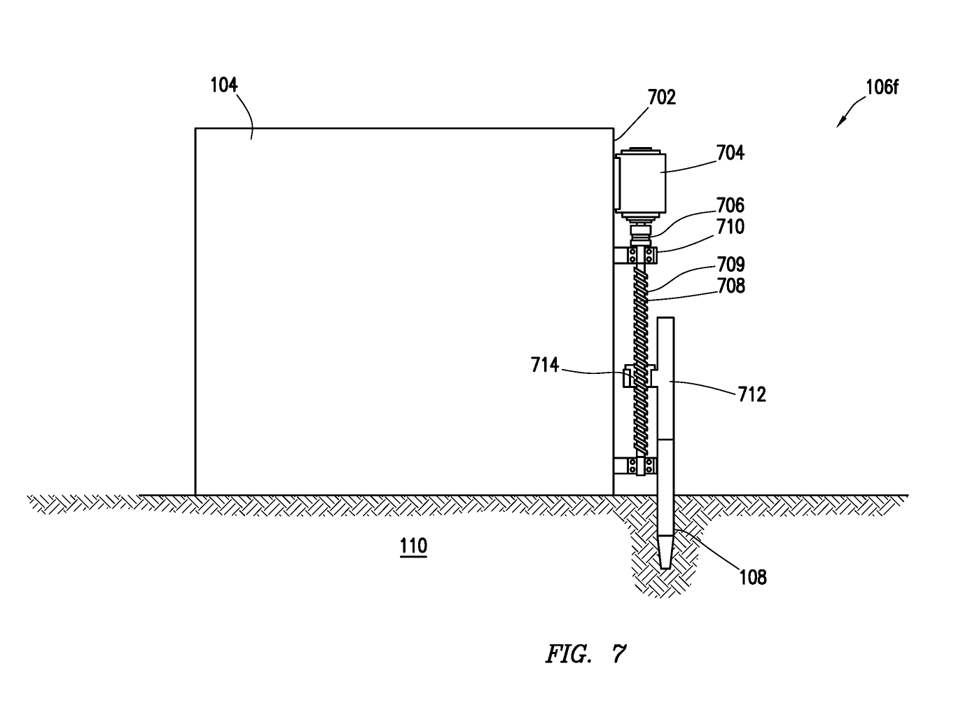

Referring now to FIG. 7, a close-up view of an actuator in accordance with the present disclosure is shown. Actuator 106 is shown as screw mechanism 106f. Screw mechanism 106f may be coupled to an exterior portion 702 of mobile unit 104. Screw mechanism 106f may comprise a motor 704 coupled to a first end 706 of a screw shaft 708. Motor 704 may comprise a hydraulic motor, an electric motor, an air motor, or any other suitable motor. Screw shaft 708 may comprise a generally cylindrical rod with a series of threads 709 extending outward radially along an exterior circumference of the rod. Screw shaft 708 is coupled to the exterior portion 702 of mobile unit 104 using one or more bearing housings 710. Bearing housings 710 allow screw shaft 708 to rotate freely, but prevent screw shaft 708 from moving relative to the mobile unit 104. Screw mechanism 106f may further comprise a translatable member 712 that is disposed around the exterior circumference of screw shaft 708. Translatable member 712 may comprise a screw engaging mechanism 714 that may be configured to engage with threads 709 of screw shaft 708. As would be understood by a person of ordinary skill in the art, having the benefit of the present disclosure, screw engaging mechanism 714 may be a lead screw mechanism, a ball screw mechanism, a roller screw mechanism, or any other suitable mechanism. Translatable member 712 may be coupled to ground rod 108. Motor 704 may be operated to rotate screw shaft 708. As screw shaft 708 rotates, the threads 709 engage with the screw engaging mechanism 714 of translatable member 712, causing translatable member to move longitudinally along the central axis of screw shaft 708. As translatable member 712 moves downwards toward grounded surface 110, ground rod 108 is pushed into grounded surface 110, penetrating a portion thereof.

In certain embodiments, the methods and systems of the present disclosure may be suitable for use with oilfield services equipment. The oilfield services equipment may comprise drilling equipment, centrifugal pumps, fracturing pumps, blenders, control trailers, storage trailers, electrical equipment, electrical cabinets, manifold units, power generation units, power distribution units, power control units, cementing units, gas compressor units, gas conditioning units, and any other suitable equipment. The oilfield services equipment may be located at a hydrocarbon drilling site, a hydrocarbon production site, or any other oilfield sites.

An embodiment of the present disclosure is a grounded mobile system comprising a mobile unit; one or more ground rods configured to penetrate a portion of a grounded surface; one or more grounding connectors coupled to the one or more ground rods and the mobile unit; and one or more actuators coupled to the mobile unit for driving the one or more ground rods into the portion of the grounded surface.

Another embodiment of the present disclosure is a method of grounding mobile equipment comprising moving a mobile unit to a grounded surface; actuating one or more actuators coupled to the mobile unit to drive one or more ground rods into the grounded surface; penetrating a portion of the grounded surface with at least one of the one or more ground rods; and coupling one or more grounding connectors to the one or more ground rods and the mobile unit. Another embodiment of the present disclosure is a method of grounding mobile oilfield services equipment comprising moving an oilfield equipment unit to a well site; actuating one or more actuators coupled to the oilfield equipment unit to drive one or more ground rods into a grounded surface; penetrating the grounded surface with at least a portion of the one or more ground rods; and coupling one or more grounding connectors to the one or more ground rods and the oilfield equipment unit.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee.

What is claimed is:

1. A grounded mobile system comprising:
a mobile unit;
one or more ground rods configured to penetrate a portion of a grounded surface;
one or more grounding connectors coupled to the one or more ground rods and the mobile unit; and
one or more actuators coupled to the mobile unit for driving the one or more ground rods into the portion of the grounded surface.

2. The system of claim 1, wherein the one or more actuators comprise one or more linear actuators.

3. The system of claim 2, wherein the one or more linear actuators are hydraulic cylinders.

4. The system of claim 2, wherein the one or more linear actuators are rack and pinion systems.

5. The system of claim 2, wherein the one or more linear actuators are screw mechanisms.

6. The system of claim 1, wherein the one or more actuators comprise one or more landing gears.

7. The system of claim 1, wherein the one or more ground rods comprise one or more hollow tubulars and the one or more actuators comprise one or more air drills.

8. The system of claim 1, wherein the one or more ground rods comprise one or more boring blades coupled to and extending spirally outward from an outer circumference of the one or more ground rods and the one or more actuators comprise one or more motors.

9. The system of claim 1, wherein the one or more grounding connectors are wires.

10. A method of grounding mobile equipment comprising:
moving a mobile unit to a grounded surface;
actuating one or more actuators coupled to the mobile unit to drive one or more ground rods into the grounded surface;
penetrating a portion of the grounded surface with at least one of the one or more ground rods; and
coupling one or more grounding connectors to the one or more ground rods and the mobile unit.

11. The method of claim 10, wherein the one or more actuators comprise one or more linear actuators, wherein the one or more linear actuators comprise one or more of a hydraulic cylinder, a linear electric motor, an air-operated cylinder, a screw mechanism, and a rack and pinion system.

12. The method of claim 10, further comprising setting one or more landing legs.

13. The method of claim 10, wherein the one or more ground rods comprise one or more hollow tubulars and wherein the one or more actuators comprise one or more air drills.

14. The method of claim 10, wherein the one or more ground rods comprise one or more boring blades coupled to and extending spirally outward from an outer surface of the one or more ground rods and wherein the one or more actuators comprise one or more motors.

15. The method of claim 10, wherein the one or more grounding connectors comprise at least one of a wire, a quick-connect interface, and a slip-joint.

16. The method of claim 10, further comprising dissipating an amount of electric charge from the mobile unit to the portion of the grounded surface.

17. The method of claim 10, wherein coupling the one or more grounding connectors to the one or more ground rods and the mobile unit is performed automatically by the one or more actuators.

18. A method of grounding mobile oilfield services equipment comprising:
moving an oilfield equipment unit to a well site;
actuating one or more actuators coupled to the oilfield equipment unit to drive one or more ground rods into a grounded surface;
penetrating the grounded surface with at least a portion of the one or more ground rods; and
coupling one or more grounding connectors to the one or more ground rods and the oilfield equipment unit.

19. The method of claim 18, wherein moving an oilfield equipment comprises at least one of a drilling equipment, a centrifugal pump, a fracturing pump, a blender, a control unit, a storage unit, a tank, electrical equipment, an electrical cabinet, a manifold unit, a power generation unit, a power distribution unit, a power control unit, a cementing unit, a gas compressor unit, or a gas conditioning unit.

20. The method of claim 18, wherein the one or more actuators comprises at least one of a hydraulic cylinder, a linear electric motor, an air-operated cylinder, and a rack and pinion system.
